(19) United States
(12) Patent Application Publication
(10) Pub. No.: US 2016/0375871 A1
(43) Pub. Date: Dec. 29, 2016

(54) MEMBER FOR A SYSTEM FOR CONNECTING A WINDSCREEN WIPER BLADE TO MULTIPLE WINDSCREEN WIPER ARMS

(71) Applicant: Valeo Systèmes d'Essuyage, Le Mesnil Saint Denis (FR)

(72) Inventors: Vincent Gaucher, Ennezat (FR); Guillaume Mouleyre, Saint Genes Champanelle (FR)

(73) Assignee: Valeo Systèmes d'Essuyage, Le Mesnil Saint Denis (FR)

(21) Appl. No.: 15/196,121

(22) Filed: Jun. 29, 2016

(30) Foreign Application Priority Data
Jun. 29, 2015 (FR) 1556022

(51) Int. Cl. B60S 1/40; B60S 1/38

(52) U.S. Cl. CPC B60S 1/40; B60S 1/3853; B60S 1/3874; B60S 1/3887; B60S 1/3806

(57) ABSTRACT

Member (10) for a connection system between a windscreen wiper blade (12) and a driving arm (22) of said blade, said member (10) comprising a body (14) having a U-shaped cross section comprising a base (16) and two lateral walls (18), and comprising at least a first retractable locking means (28) configured in order to interact with an arm (22) having a terminal piece (20) of a first type and carried by at least a first elastic tab (32) comprising at least a first notch (40), said member (10) comprising at least a second retractable locking means (38) configured in order to interact with an arm (36) having a terminal piece (34) of a second type, said second locking means (38) being carried by at least a second elastic tab (42), characterised in that the first and second elastic tabs (32, 42) start from the base (16) and extend in the plane of the base (16).

### TECHNICAL FIELD

The present invention relates to a member for a system for connecting a windscreen wiper blade of, in particular, a motor vehicle.

### PRIOR ART

A motor vehicle is conventionally equipped with windscreen wipers for washing the windscreen and avoiding disruption to the driver's view of his surroundings. These windscreen wipers generally comprise a driving arm that carries out an angular back-and-forth movement and have elongate blades which themselves carry squeegee blades made of a resilient material. These squeegee blades rub against the windscreen and evacuate the water by removing it from the driver's field of view. The blades are produced in the form either, in a conventional version, of articulated brackets which hold the squeegee blade at a number of discrete locations, giving it a bend that allows it to follow whatever curvature the windscreen may have, or, in a more recent version, known as the “flat blade” version, of a semi-rigid assembly which holds the squeegee blade along its entire length by virtue of one or more bend-forming vertebrae making it possible to press the blade against the windscreen without having to use brackets.

In both solutions, the blade is attached to the driving arm by a connection system having a connector and an adapter. The connector is a piece which is secured to the blade and which is generally fastened directly to the squeegee blade or to the flat structure of the blade, whereas the adapter is interposed between the connector and the arm. The adapter is an intermediate piece that allows the linking and the fastening of the connector on the driving arm and which is locked in a terminal piece of the driving arm by a retractable locking means.

In the current state of the art, there are only a few varieties of adapter that can be adapted selectively to several varieties of terminal pieces or of ends of driving arms of different types, which is neither practical nor economical. This state of affairs is the result of the actual design of the elastic return of the locking means. Adapters generally comprise a body that has a U-shaped cross section comprising an upper wall or base and two lateral walls. The upper wall or base comprises the locking means, which are generally in the form of locking buttons mounted on elastic tabs and are designed to snap-fit into corresponding holes in the terminal pieces of the arms.

There are different types of arms, each of which comprise different terminal pieces in which holes of different sizes and/or differently positioned holes are provided.

As adapters are generally small in size, the total longitudinal spatial requirements of the buttons and of their elastic tabs does not, as a rule, allow for the provision of a plurality of locking buttons on the upper face of the adapter, which restricts the number of possibilities of different terminal pieces for which the adapter may be provided.

Furthermore, the adapter has to fulfil other functions, particularly that of pivoting the arm and, consecutively, the connector, relative to the adapter. To that end, the cavity delimited by the base and the two lateral walls has to be capable of receiving a connector integrated into the blade.

There is thus a genuine need for a universal adapter that is capable of being mounted on at least two, and even many more, terminal pieces of windscreen wiper arms of different types, said terminal pieces each having a hole of which the size and/or the positioning are specific to said terminal piece.

A solution of this type is thus particularly advantageous and economical.

### SUMMARY OF THE INVENTION

To meet this need, the invention proposes a member for a system for connecting a windscreen wiper blade to a driving arm of said blade, comprising a high number of fastening means. To that end, the invention proposes a member capable of receiving a high number of locking buttons and of elastic tabs, enabling the elastic return of these buttons to be guaranteed.

For that purpose, the invention proposes a member for a connection system between a windscreen wiper blade and a driving arm of said blade, said member being of substantially longitudinal orientation and comprising at least one body having substantially a U-shaped cross section comprising a base and two lateral walls, said member comprising at least a first retractable locking means configured in order to interact with an arm having a terminal piece of a first type, said first locking means comprising at least a first elastic tab, said first elastic tab comprising at least a first notch, said member comprising at least a second retractable locking means configured in order to interact with an arm having a terminal piece of a second type, said second locking means comprising at least a second elastic tab, characterised in that the first and second elastic tabs start from the base and extend at least in part in a thickness of the base.

This configuration makes it possible to arrange, on the upper face of the member, two locking means, for example two buttons, with a reduced longitudinal spatial requirement.

In the description given below, the elastic or flexible property of the tabs forming the locking means has the result that same are configured in order to be elastically deformable, i.e. capable of resuming their initial position, called the rest position, upon a command effort corresponding to initiation of operation.

According to other characteristics of the invention:

the first elastic tab, called first tab, comprises at least two arms connected to the base of the body of the member, between which a notch is delimited,

the second locking means extends into the notch,

the first and second locking means are constituted by respective first and second push buttons that extend in the thickness of the base or above a heel delimiting a face of the base turned towards the terminal piece,

the first push button is provided at a distal end of the first elastic tab,

the second push button is provided at a distal end of the second elastic tab,

the member comprises a means of pivoting about a transverse axis, and the body has the shape of a U in a section passing via the transverse axis, the U shape comprising at least the upper wall and the two lateral walls, provided in line with the means of pivoting,

the first and second elastic tabs extend in accordance with the longitudinal orientation of the member, i.e. mainly in accordance with this longitudinal orientation,

the member comprises a third locking means configured in order to interact with an arm having a terminal piece of a third type, said third locking means comprising at least a third elastic tab extending from an internal face of one of the lateral walls of the body,

the body comprises a first end via which it is capable of being inserted into each terminal piece, and a second end, opposite the first end, and the first, second and third locking means are aligned longitudinally between the first and second ends,

the member comprises a fourth locking means configured in order to interact with an arm having a terminal piece of a fourth type, said fourth locking means comprising at least a fourth elastic tab extending in the continuation of at least one of the lateral walls of the body,

the member comprises a head formed at the second end of the member, with the head, in this case, being higher and broader than the body,

a housing for receiving at least one of the terminal pieces of the arm is arranged between the body and at least one wing lateral to the body emerging from the head,

the member is produced by injection-moulding of a plastics material,

the terminal piece of a second type is distinct from the terminal piece of the first type at least in that a hole, for example provided on the upper face of the terminal piece, the size and/or the positioning of which are specific,

at least one part of the second elastic tab extends into the first notch,

the member is configured in order to be mounted by translation in accordance with the longitudinal direction in the first type of terminal piece and in the second type of terminal piece,

the first locking means being accommodated in an opening formed in the base of the body,

the second elastic tab extends at least in part opposite the opening,

the first locking means is closer to the first end of the body of the member than is the second locking means,

the first, second and third locking means are aligned longitudinally between the first and second ends, the opening emerges at, or on a level with, the first end of the body.

Lastly, the invention relates to a windscreen wiper blade comprising a member of the type described above.

### DESCRIPTION OF FIGURES

The invention will be better understood and further details, features and advantages of the invention will become apparent from reading the following description given by way of non-limiting example and with reference to the appended drawings, in which:

FIG. 1 is a schematic perspective view of a windscreen wiper, this windscreen wiper having a windscreen wiper blade, an arm for driving the blade, and a system for connecting the windscreen wiper blade to the arm,

FIGS. 2A and 2B are perspective views from above of a member according to the invention;

FIG. 3 is a perspective view from below of a member according to the invention,

FIGS. 4 to 9 are respective perspective views of the terminal pieces of the first to sixth arms designed to interact with the member according to the invention,

FIGS. 10 to 15 are perspective assembled views from above of the member and of the terminal pieces of the first to sixth arms according to the invention,

FIG. 16 is a perspective assembled view from below of the member and of the terminal piece of the first arm according to the invention.

### DETAILED DESCRIPTION

In the following description, identical reference numbers denote identical pieces or pieces having similar functions.

It should be noted that the figures explain the invention in detail for implementing the invention, it being, of course, possible for said figures to serve to better define the invention if necessary.

Furthermore, in the following description, the terms ‘longitudinal’ or ‘lateral’ refer to the orientation of the windscreen wiper blade or of the driving arm according to the invention. The longitudinal direction corresponds to the main axis of the windscreen wiper blade, while the transverse and vertical orientations correspond to concurrent lines, that is, lines which cross the longitudinal direction, notably perpendicular to the longitudinal axis of the windscreen wiper blade. For the purposes of satisfactory comprehension of the invention, the figures may be oriented with reference to the ‘X-Y-Z’ scheme.

Finally, the directions referenced ‘upper’ or ‘lower’ correspond to orientations perpendicular to the plane of rotation of the windscreen wiper blade, the term ‘lower’ being turned towards the plane of the windscreen and the term ‘upper’ being turned away from this plane.

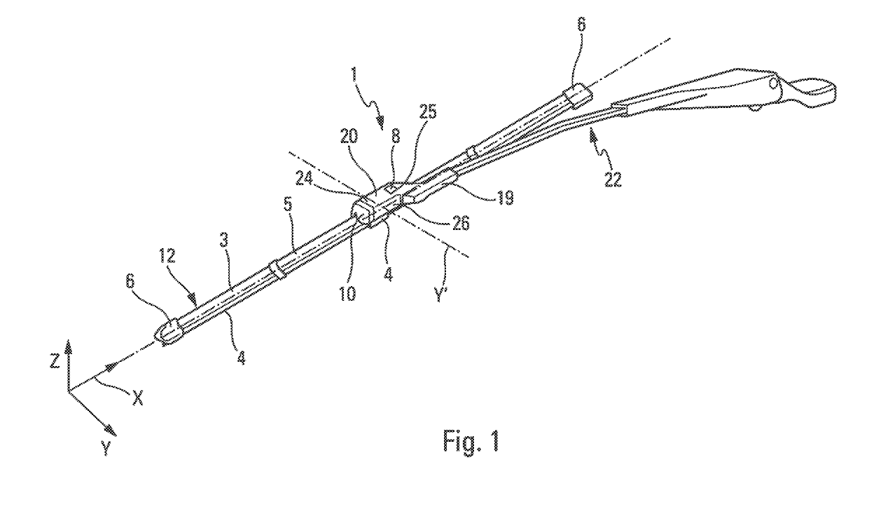

FIG. 1 illustrates a windscreen wiper 1 having notably a windscreen wiper blade 12 and an arm 22 for driving the windscreen wiper blade 12.

The windscreen wiper blade 12 is preferably of the flat blade type and comprises a longitudinal body 3 oriented substantially in accordance with a longitudinal axis X, a squeegee blade 4, generally made of rubber or of elastomeric material, and at least one vertebra (not visible) which stiffens the squeegee blade and encourages it to press against a vehicle windscreen.

The body 3 of the windscreen wiper blade 12 may comprise an upper aerodynamic deflector 5 intended to improve the operation of the wiping system, the purpose of this deflector being to improve the pressing of the windscreen wiper blade against the windscreen and thus the aerodynamic performance of the windscreen wiper.

The windscreen wiper blade 12 may further comprise and fittings 6 or clips for attaching the squeegee blade 4 and the vertebra to the body 3, these fittings 6 being situated at each of the longitudinal ends of the body 3.

The windscreen wiper blade 12 comprises, substantially at its middle, an intermediate connector 4. A member 10 forming an adapter secured to the arm 22 is mounted on the connector 4 so as to maintain a degree of freedom to pivot about a rotation axis Y′ which is a transverse axis parallel to a transverse direction Y substantially perpendicular to the longitudinal axis X of the windscreen wiper blade 12. This degree of freedom allows the windscreen wiper blade 12 to pivot with respect to the arm 22 and thus allows the windscreen wiper blade 12 to follow the curvature of the windscreen as it moves. The member 10 is designed configured in order to be mounted by translation in accordance with the longitudinal direction X in a terminal piece 20 of the arm 22, from which it may be detached by pressing on a locking means.

The arm 22 is intended to be driven by a motor to follow an angular back-and-forth movement that allows water and possibly other undesirable elements with which the windscreen is covered to be evacuated. The adapter 10 provides the connection of the windscreen wiper blade 12 to the arm 22 and, in particular, to the terminal piece 20 of the arm 22 which may be formed as one piece with the an 22 or attached and fastened thereto.

In the example shown, the terminal piece 20 of the arm forms a yoke having a transverse section substantially in the form of a U.

The terminal piece 20 has an elongate shape, the axis of elongation of which is generally substantially parallel or coaxial to the axis of elongation X or longitudinal axis of the windscreen wiper blade 12. In the remainder of the present description, in a manner that does not limit same, the axis of elongation of the terminal piece 20 will be deemed to correspond to the axis X.

The terminal piece 20 comprises a part 19 for connecting to the rest of the arm 14. This part 19 has an elongate overall shape and extends substantially parallel to the axis X and spaced apart from this axis X, as can be seen in FIG. 1. The part 19 is connected to a rear end of the rest of the terminal piece 20.

With reference to FIG. 1, the terminal piece 20 comprises two lateral walls 26, the upper longitudinal edges of which are connected together by an upper transverse wall 24. Between them, the lateral walls 26 and the wall 24 delimit a space for accommodating the adapter 10. The lateral walls 26 may comprise at the level of their lower longitudinal edges means for retaining the adapter 10, which will be described in greater detail in the remainder of the present description.

The upper wall 24 may comprise a through-hole 25 of a shape that complements the push button 8. In the mounted position, the push button 8 is accommodated in this hole 25 and is able to pass through the latter so as to project from the upper face of the wall 24. Mounting of the push button 8 in the hole 25 takes place by means of simple engagement or fitting, preferably by elastic snap-fitting.

In this design, the member 10 may be mounted only in the specific type of arm 22 illustrated and, more particularly, in the particular type of corresponding terminal piece 20, which is neither practical nor economical since it is necessary, when the windscreen wiper blade 12 is to be mounted on a different arm, to use another type of member or adapter 10. The member 10 cannot, for example, be mounted in a terminal piece having a hole 25 of different size and/or a hole positioned differently.

One drawback of the prior art systems is that, in order to be retractable, they have to be mounted at the end of elastic tabs that are generally oriented in accordance with the longitudinal direction X. These tabs have to be of sufficient length to flex sufficiently and thus to have sufficient elasticity to allow sufficient vertical deflection of the button. In point of fact, as the members or adapters 10 are generally small in size, the total longitudinal spatial requirement of the buttons and of their elastic tabs does not, as a rule, allow for the provision of a plurality of locking buttons on the upper face of the adapter, which restricts the number of possibilities of terminal pieces for which the adapter may be provided.

There is thus a genuine need for a universal adapter that can be mounted selectively on at least two, and even many more, distinct terminal pieces for a windscreen wiper arm, without interfering with the pivoting of the connector 4 of the blade 12.

To that end, the invention makes it possible to propose a member for a system for connecting a windscreen wiper blade to a driving arm of said blade, comprising a high number of fastening means and, in particular, a high number of locking buttons borne by elastic tabs with a small spatial requirement.

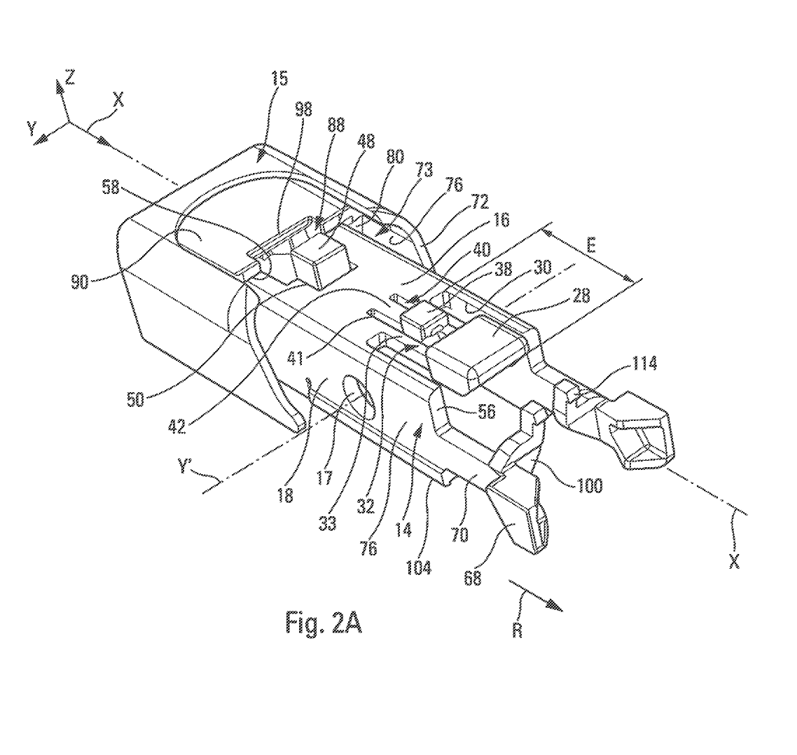

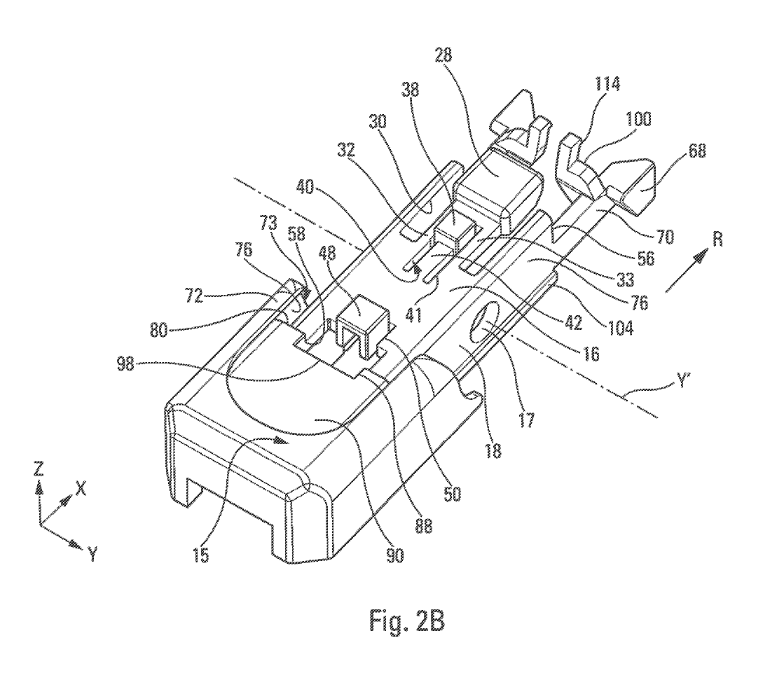

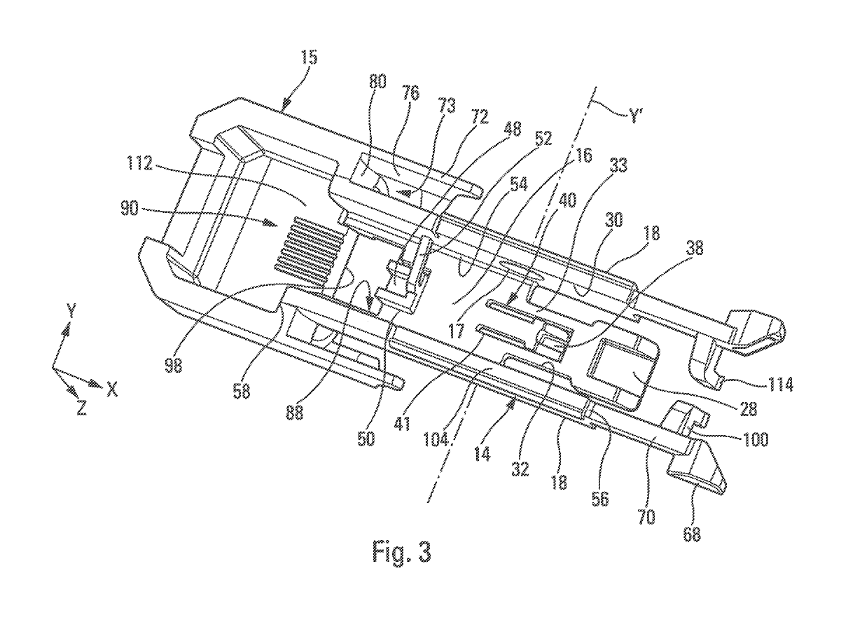

To this purpose, the invention proposes a member 10 or adapter for a system for connecting a windscreen wiper blade to a driving arm 22 of said windscreen wiper blade 12, produced in accordance with FIGS. 2A, 2B and 3.

The member 10 has a substantially longitudinal orientation X and it comprises at least one body 14 having substantially a U-shaped cross section, This body 14 comprises an upper wall 16, otherwise called the base, and two lateral walls 18 substantially parallel to one another and substantially perpendicular to the base 16. The lateral walls comprise, for example, two apertures 17 aligned transversely and designed to embody the axis of pivoting Y′ of the windscreen wiper blade 12, for example by receiving complementary studs (not shown) carried by the connector 4.

It will be understood that the means of pivoting could have many other forms, for example, and in a manner that does not limit the invention, apertures designed to receive a rod traversing the connector of the arm or designed to receive journals originating from the connector, or non-through bosses designed to receive the journals projecting from the connector in order to form two swivel-type connections that can be fitted together by separation of the lateral walls 18 from the body 14. Alternately, the member may comprise two protuberances oriented towards one another and made as one piece with the member. These protuberances are then received in cavities made in the connector.

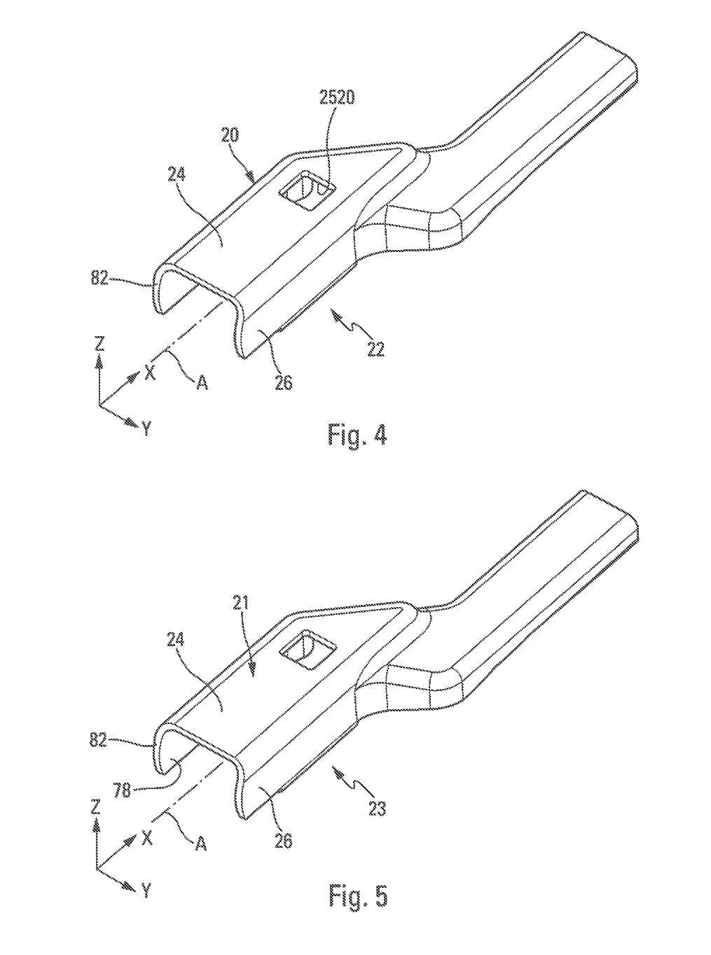

The member 10 is configured in order to be mounted by translation in accordance with the longitudinal direction X in a terminal piece 20 of a first type of arm 22, which will in the remainder of the present description be called first terminal piece 20 of the first arm 22, as previously shown in FIG. 1 and as is shown in FIG. 4. The first terminal piece 20 is delimited by an upper wall 24 and two lateral walls 26 that are substantially parallel to one another and perpendicular to the upper wall 24. A first terminal piece 20 of this type has, for example, been represented in FIG. 4.

As illustrated in FIGS. 2A and 2B, the body 14 of the member 10 according to the invention comprises at least one first locking means 28 that is configured in order to interact with said first terminal piece 20 of the first arm 22. In the preferred embodiment of the invention, this first locking means is constituted by a push button 28 designed to penetrate a hole 2520 in said first terminal piece 20. It will be understood that this configuration does not limit the invention and that the first locking means 28 could have any other shape designed to ensure its function, such as, for example, that of a pin or that of a barb.

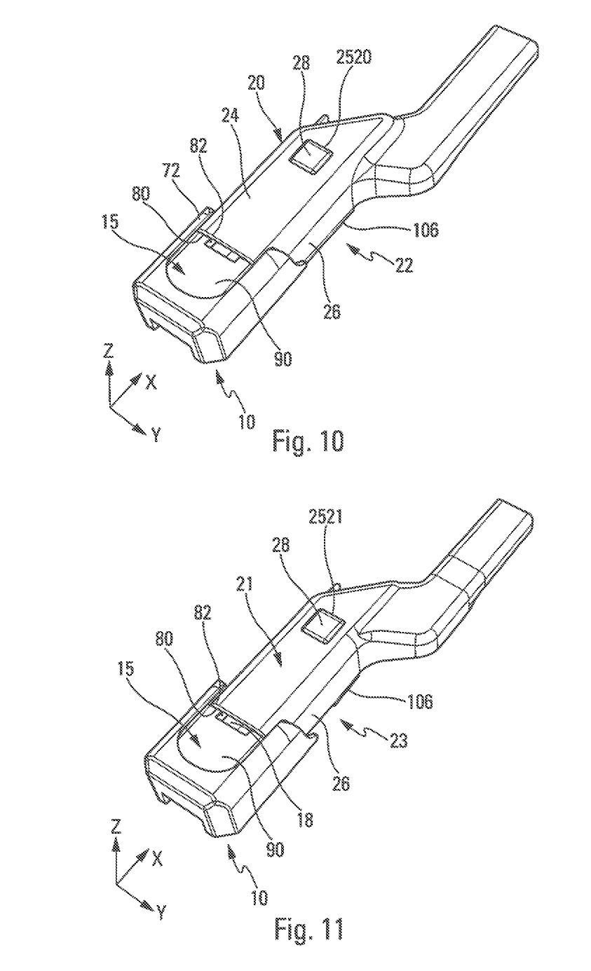

The push button 28 is carried by a first elastic tab 32 extending at least in part into the opening 30 in such a manner as to allow elastic return of the push button 28, which enables it to be snap-fitted in the hole 2520 of the first terminal piece 20, as shown in FIG. 10.

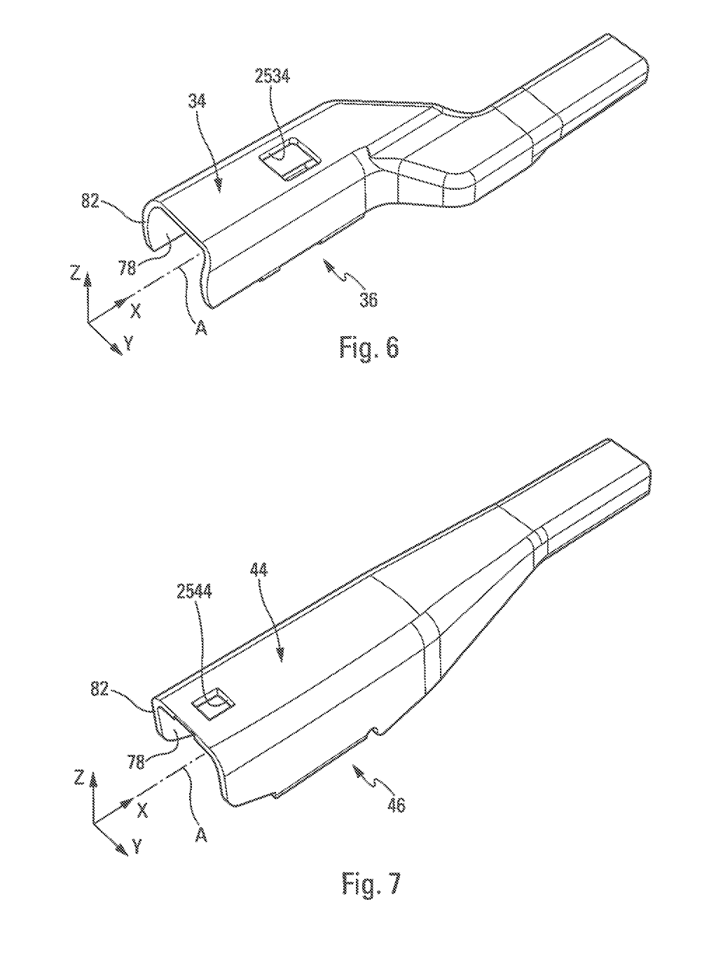

The member 10 is configured in order to be selectively mounted, still by translation in accordance with the longitudinal direction X, in a terminal piece 34 of at least one arm 36 of another type, as shown in FIG. 6. To that end, it comprises at least one second retractable locking means 38 configured in order to interact with said terminal piece 34 of the other arm 36 of a second type that is different from the first type.

In the preferred embodiment of the invention, this second locking means 38 is constituted by a second push button 38 designed to penetrate and to snap-fit into a hole 2534 in the terminal piece 34. It will be understood that this configuration does not limit the invention and that the second locking means 38 could have any other shape designed to ensure its function, such as, for example, that of a pin or that of a barb.

In configurations previously known from the prior art, a plurality of locking means implies that they are arranged one after another such that they account for a significant spatial requirement in the longitudinal direction X. Furthermore, mechanical interferences may arise, particularly in line with the apertures 17, which restricts the placement of locking means.

The invention remedies this drawback by proposing locking means comprising locking means included in one another in such a manner as to propose a reduced longitudinal and vertical spatial requirement.

To that end, as illustrated, in particular, in FIGS. 2A, 2B and 3, the invention proposes a member 10 of which the first and second elastic tabs 32, 42 start from the base 16 and extend in the plane of the base 16 of the body 14. Advantageously, the first elastic tab 32 comprises at least a first notch 40. The second retractable locking means 38 extends at least in part into the first notch 40.

The second locking means 38, which is constituted, in a non-limiting manner, by a second push button 38, is carried by at least one second elastic tab 42 extending, likewise, at least in part into the first notch 40.

The member 10 may comprise a continuation 41 of the notch 40 extending in the base 18. The second tab 42 may thus extend into the second notch 40 and into the continuation 41 of the first notch 40. Advantageously, there is a plane from which a flexing of the locking means may be implemented, this plane being common to the first and to the second locking means, i.e. passing therethrough in the rest position.

As illustrated in FIG. 2A, this configuration makes it possible to propose first and second elastic tabs 32, 42 and associated push buttons 28, 38 having a reduced spatial requirement.

In the preferred embodiment of the invention, the first elastic tab 32 comprises at least two arms 33 connected to the body 14 of the member 10, which delimit at least in part the first notch 40.

In the preferred embodiment of the invention, the first elastic tab 32 of the first locking means 28 and the second elastic tab 42 of the second locking means 38 extend in the plane of the base 16 of the body 14.

As seen, in the preferred embodiment of the invention, the first locking means 28 comprises a first push button 28. This first push button 28 is provided at a distal end of the first elastic tab 32, which makes it possible to propose a maximum flexing of the first push button 28. Furthermore, the first locking means 28 is accommodated in an opening 30 formed in the base 16 of the body 14.

It will thus be understood that each locking means is at least constituted by one elastic tab, at the end of which at least one push button is formed.

In this configuration, the second elastic tab 42, which extends at least in part into the first notch 40, extends at least in part opposite the opening 30.

Similarly, the second locking means 38 comprises, in a preferred manner of the invention, a second push button 38 formed at a distal end of the second elastic tab 32, which likewise makes it possible to propose a maximum flexing of the second push button 38.

The first button 28 and the second button 38 extend in or above the plane of the base 16.

Advantageously, the opening 30, the first notch 40 and the first and second elastic tabs 32, 42 extend in accordance with the longitudinal direction X of the member 10 in such a manner that the first and second elastic tabs 32, 42 and the associated push buttons 28, 38 have a reduced longitudinal spatial requirement E. This configuration is preferably obtained when the first and second elastic tabs 32, 42 extend in the same direction R in accordance with said longitudinal direction X, for example towards the rear of the member 10.

Thus, that part of base 16 of the member 10 not occupied by the first and second tabs 32, 42 and the associated push buttons 28, 38 may be provided in order to interact with other types of arms, as may be seen in the remainder of the present description.

Furthermore, the tabs 32 and 42 are both located in the plane of the base 18 such that they cannot in any event disrupt the pivoting of the connector in the member 10. The tabs may thus be arranged substantially in line with the apertures 17.

In the preferred embodiment of the invention, the member 10 is configured in order to be mounted by translation in accordance with the longitudinal direction X, then locked in first or second terminal pieces 20, 21 of arms 22, 23 of first or second types, said terminal pieces having been shown in FIGS. 4 and 5, by means of the first button 28, or in a third terminal piece 34 of an arm 36 of a third type, such as shown in FIG. 6, by means of the second button 38.

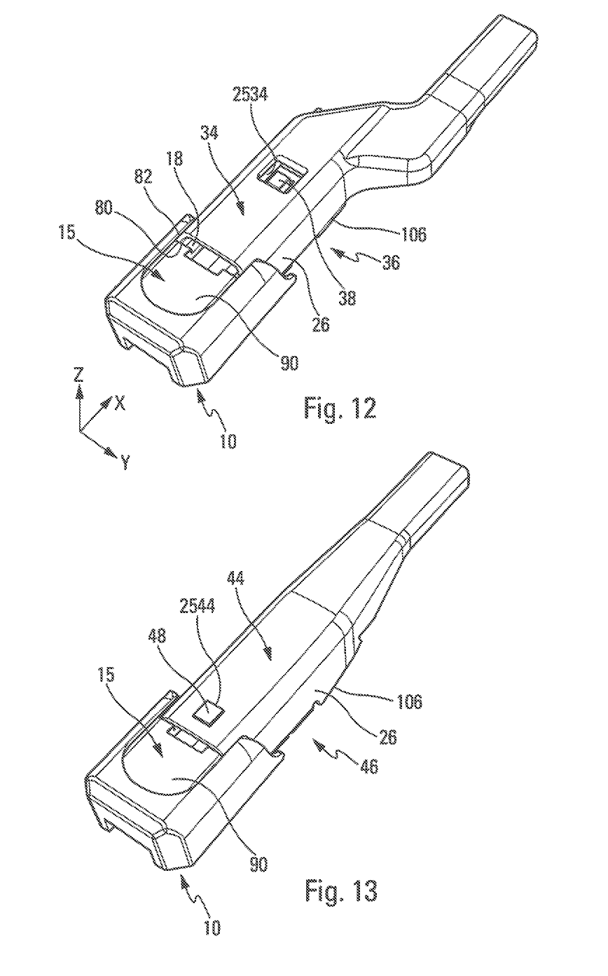

In particular, the first locking push button 28 is configured in order to interact with the second terminal piece 21, penetrating a hole 2521 of said second terminal piece 21, and the second push button 38 is configured in order to interact with the third terminal piece 34, penetrating a hole 2534 of said third terminal piece 34, as shown, respectively, in FIGS. 11 and 12.

In the preferred embodiment of the invention, the body 14 comprises a first end 56 via which it is capable of being inserted into each terminal piece, and a second end 58 opposite the first end 56. The second end 58 is, in particular, alongside a head 15 formed at the end of the member 10.

In this configuration, the first locking means, constituted at least by the first push button 28, is preferably closer to the first end 56 of the body 14 of the member 10 than is the second locking means constituted, in particular, by the second push button 38. This configuration, however, does not limit the invention.

It will be noted that the dimensions of the first push button 28 are greater than the dimensions that delimit the second push button 38.

The elastic tab of the first locking means extends, for example, in a plane parallel to the elastic tab of the second locking means. The thickness of the elastic tab of the second locking means is, for example, equal to or less than the thickness of the elastic tab of the first locking means, the second elastic tab thus being contained within the spatial requirement of the first elastic tab.

As seen, that part of base 16 of the member 10 not occupied by the first and second tabs 32, 42 and the associated push buttons 28, 38 may thus be provided in order to interact with other types of arms. To that end, the member 10 is configured in order to be mounted by translation in accordance with the longitudinal direction in a terminal piece 44 of at least one arm 46 of a fourth type, said fourth terminal piece having been shown in FIG. 4. In the present case, the member 10 comprises at least one retractable locking means 48 constituted in a manner that does not limit the invention by a third locking push button 48, which is configured in order to interact with said fourth terminal piece 44, said third button 48 being accommodated in a second notch 50 formed in the upper wall 16 of the body 14 and carded by a third flexible elastic tab 52 extending transversely relative to the longitudinal direction X from a wall of the body 14. The third button 48 is designed to interact with a hole 2544 of the fourth terminal piece 44 of the arm 46 of the fourth type.

As may be ascertained, the transverse arrangement of the third elastic tab 52 is particularly advantageous in that it limits the spatial requirement in the longitudinal direction X.

Preferably, the third elastic tab 52 extends from an internal face 54 of one of the lateral walls 18 of the body 14. This configuration makes it possible to propose an inclined third elastic tab 52 of sufficient length to confer on it a flexibility allowing the manipulation of the third push button 48, which would not be the case if the third elastic tab were carried by the upper face 16 of the member 10. The third push button 48 is of a size and of dimensions between those of the first and second push buttons.

In the preferred embodiment of the invention, the first push button 28, the second push button 38 and the third push button 48 are arranged in alignment in accordance with the longitudinal direction X of the first end 56 of the body 14 towards the second end 58. It should be noted that this arrangement could be reversed, without altering the nature of the invention, the first push button 28 and second push button 38, which are necessarily alongside one another, then being arranged on the side of the second end 58 of the body 14 and the third push button 48 being arranged on the side of the first end 56.

It will be likewise noted that, in the preferred configuration of the invention whereby the first push button 28 and the second push button 38 are arranged close to the first end 56 of the body 14, the opening 30 opens at the first end 56 of the body 14.

The body 14 preferably being produced by injection-moulding of a plastics material, this configuration allows, in particular, simplification of the removal of said body 14 from the mould.

The configuration described above makes it possible to optimise the distribution of the locking means, in particular the push buttons 28, 38, 48, on the base 16 of the member 10. Nevertheless, it is possible to make a provision advantageously for supplementary locking means, providing these on or in the lateral walls 18.

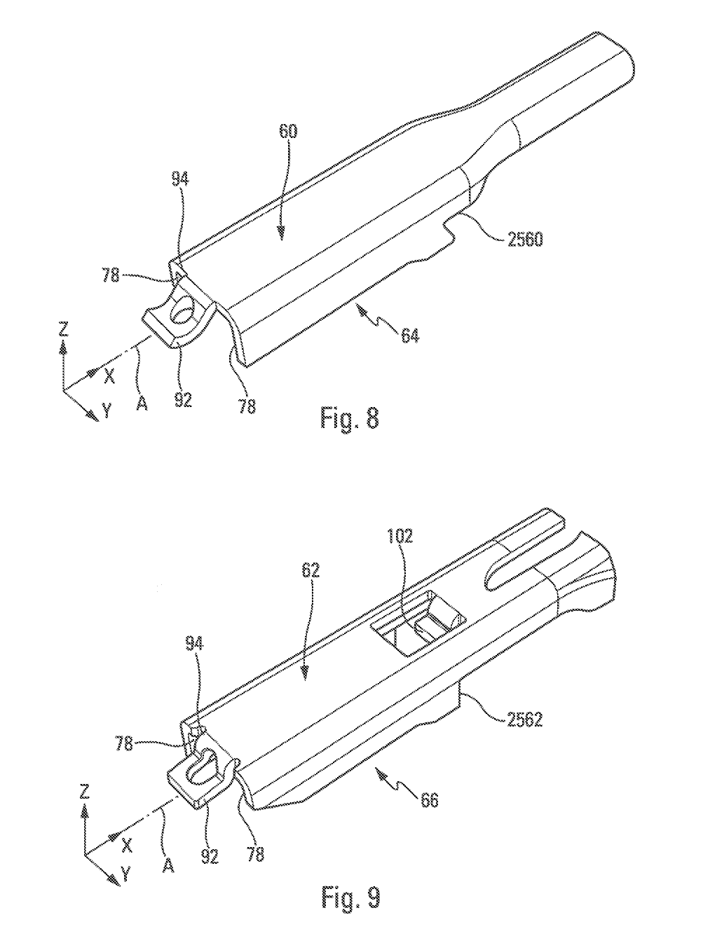

Thus, according to the invention, the member 10 is likewise configured in order to be mounted by translation in accordance with the longitudinal direction X in a fifth terminal piece 60 of an arm 64 of a fifth type and in a sixth terminal piece 62 of an arm 66 of a sixth type, which have been shown in FIGS. 8 and 9. To that end, the member 10 comprises at least two fourth lateral locking push buttons 68, which are transversely opposed, configured in order to interact with the fifth and sixth terminal pieces 60, 62. In particular, the fifth terminal piece 60 comprises, to that end, two lateral notches 2560 formed at the end of the fifth terminal piece 60, which complement the fourth push buttons 68. Similarly, the sixth terminal piece 62 comprises, to that end, two lateral notches 2562 formed at the end of the sixth terminal piece 62, which complement the fourth push buttons 68.

Preferably, as illustrated in FIGS. 2A to 3, the fourth buttons 68 are carried by fourth elastic tabs 70 extending longitudinally from the first end 56 of the body 14 in the continuation of the lateral walls 18 from the end 56 of the body 14 The fourth tabs 70 may thus be configured so as to have a long length suitable of conferring the required flexibility on the fourth buttons 68. The fourth push button 68 mentioned here is positioned against a portion of the terminal piece concerned.

In addition to the locking buttons 28, 38, 48, 68, the member 10 comprises means for transverse holding of the member 10 in the various terminal pieces 20, 21, 34, 44, 60, 62 of the arms 22, 23, 36, 46, 64, 66 on which it may be mounted.

Thus, as illustrated in FIGS. 2A to 3, the member 10 comprises first means for transverse holding of the first arm 22. These means comprise two wings 72 that extend, with clearance, from the head 15 in the direction of the body 14 parallel to the lateral walls 18 of said body 14, defining a housing 73 for receiving at least one of the terminal pieces. For example, the wings 72 are designed to receive, against their interior faces 74, exterior faces of the lateral walls 26 of the first terminal piece 20 of the first arm 22, as shown in FIG. 10.

Similarly, the lateral walls 18 of the member 10 comprise planar external surfaces 76 that form second means for transverse holding of the member 10 relative to the second to sixth terminal pieces 21, 34, 44, 60, 62 of the arms 23, 36, 46, 64, 66 of the second to sixth types. The walls 18 are designed to receive interior faces 78 of the lateral walls 26 of the second to sixth terminal pieces 21, 34, 44, 60, 62. These walls are shown in FIGS. 5 to 9.

It will be noted that a distance measured perpendicularly to the lateral walls 26 and between these is identical for the terminal pieces of first type and of second type referenced 20 and 21. This distance is, for example, equal to 22 mm. These terminal pieces 20 and 21 comprise, at the end of each lateral wall, an edge folded towards the opposite lateral wall, The terminal piece 21 of the second type is distinguished from the terminal piece 20 of the first type in that at least one of the folded edges and, for example, both folded edges, is interrupted, that is to say discontinuous. In other words, provision is made for a plurality of folded edges at the end of each lateral wall of the terminal piece 21 of the second type.

The third terminal piece 34 differs from the second terminal piece 21 only in terms of the distance measured perpendicularly to the lateral walls 26 and separating these latter. This distance is, here, 19 mm.

In addition to the locking means and the means for transverse holding, the member 10 comprises longitudinal abutment means of the various terminal pieces of the arms on which they may be mounted.

The head 15 of the member 10 has a transverse spatial requirement in the direction V that is greater than that of the body 14. Thus, together with the body 14, at the bottom of the housings 73 it delimits transverse faces BO formed at the junction of the body 14 and of the head 15, these transverse faces 80 being formed at the junction of the body 14 and of the head 15 and extending transversely from the lateral walls 18 of the body 14. These transverse faces 80 are configured in order to receive in abutment an end 82 of the first to third terminal pieces, as shown in FIGS. 10 to 12, and thus form first means of longitudinal abutment of the first to third terminal pieces 20, 21, 34 in the direction X.

The member 10 may comprise other abutment means. Thus, the terminal piece 62 of the arm 66 of the sixth type comprises a complementary tab 102 extending in parallel under the plane of the upper wall 24 of this terminal piece 62. In this configuration, the member 10 comprises second means of longitudinal abutment for this tab 102 of the sixth arm 66. As illustrated in FIGS. 2A to 3, these second abutment means comprise two fifth tabs 100 extending transversely towards the interior of the body 14 from fourth elastic tabs 70 in order to form an abutment against the complementary tab 102 of the arm 66 of the sixth type.

In addition to the locking means 28, 38, 48, 68, the means for transverse holding and the means of longitudinal abutment, the member 10 comprises means for vertical retention of the member 10 in the terminal pieces of the various arms 22, 23, 36, 46. 64, 66 in the vertical direction Z.

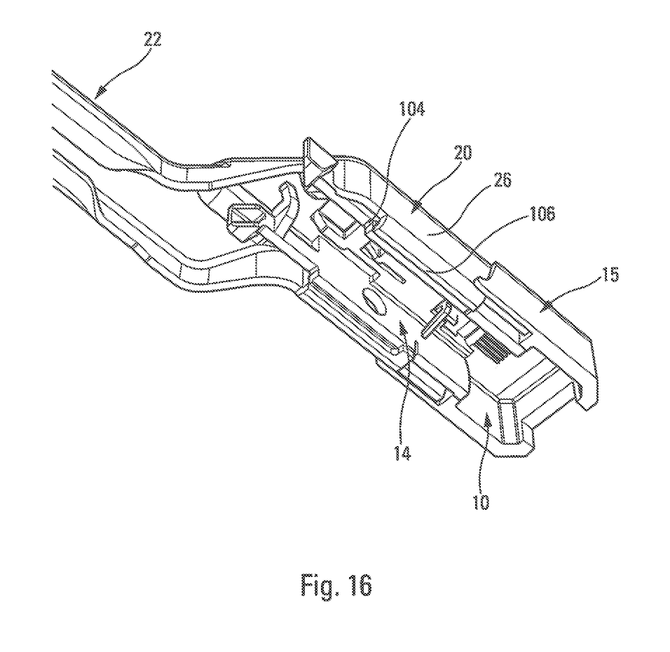

As illustrated in FIGS. 3 and 16, free lower edges 104 of the lateral walls 18 of the body 14 form first means of vertical retention of the member 10 in the first to fourth terminal pieces 20, 21, 34, 44 capable of interacting with wings 106 extending towards the interior from the lower edges 108 of the lateral walls 110 of the arms 22, 23, 36, 46 of the first to fourth types. This configuration is shown, by way of example, in FIG. 16, which shows the terminal piece 20 of the first arm 22, the wings 106 of which are designed to retain the lower edges 104 of the member 10.

Each of the first to fourth terminal pieces of the arms 22, 23, 36, 46 of the first to fourth types comprises at least two similar wings 106.

Advantageously, the member 10 may determine complementary vertical retention means for certain types of arm terminal pieces, in particular for the fifth and sixth terminal pieces 60 and 62 of the arms 64 and 66 of the fifth and sixth types, which comprise an end tab 92 extending from a transverse end edge 94 of the upper wall 24 of said terminal pieces 60, 62 parallel to said upper wall 24, as shown in FIGS. 8 and 9.

Thus, the member 10 comprises a third notch 88 extending, in a straddling manner, between the upper face 16 of the body 14 and an upper wall 90 of the head 15. The notch 88 is configured in order to receive in a complementary manner the complementary end tab 92 of the fifth or sixth terminal pieces 60, 62 which is thus capable of extending under the upper wall 90 of the head 16 shown in FIG. 3.

The second and third notches 50, 88 are preferably adjacent. Preferably, in order to facilitate removal of the member 10 from the mould after its plastics injection-moulding, the second and third notches 50, 88 are in communication with one another.

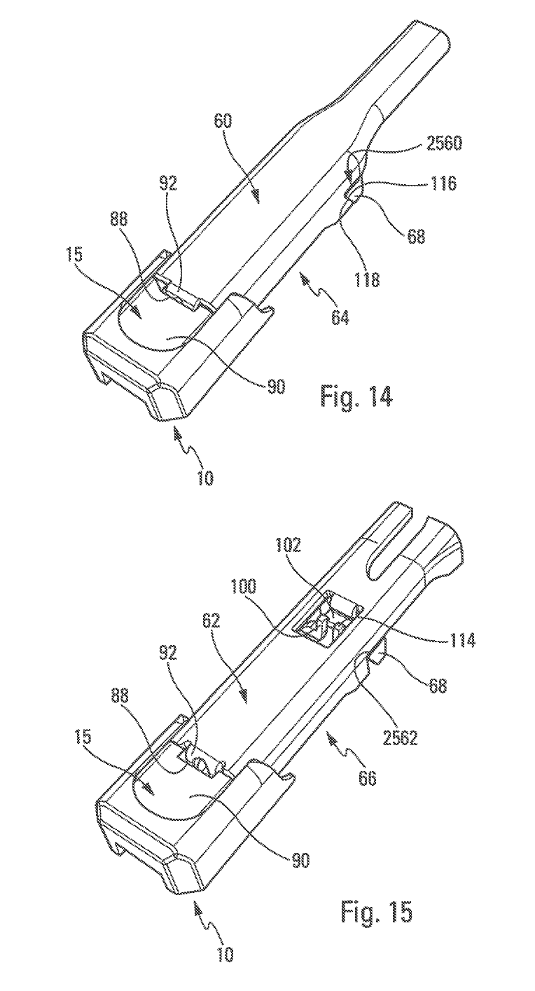

Vertical retention of the terminal pieces may also be provided differently, but in a complementary manner, particularly in the case of the fifth and sixth terminal pieces 60, 62. Thus, as illustrated in FIG. 14, edges 116 of the fourth lateral locking push buttons 68, which are inclined relative to the vertical, are configured in order to interact with complementary edges 118 of notches 2560 for receiving said fourth buttons 68 formed in the fifth terminal piece 60 in order to form means for vertical retention of the fifth terminal piece 60. In this case, therefore, vertical retention is shared with the fourth locking buttons 68.

Likewise, vertical retention may be shared with abutment means. Thus, as illustrated in FIG. 15, upper ends 114 of the fifth tabs 100 are formed as hooks and designed to interact with the complementary tab 102 of the sixth terminal piece 60 of the sixth arm 66 extending in parallel under the upper face 24 of said terminal piece 60 so as to form vertical retention means specific to said sixth arm 66.

FIGS. 10 to 16 illustrate different terminal pieces 20, 21, 34, 44, 60 and 62 of different arms 22, 23, 36, 46, 60, 66 receiving the member 10.

As illustrated in FIG. 10, the member 10 is immobilised by the lateral walls 26 of the first terminal piece 20 of the arm 22 of the first type which are received in the housing 73 between the wings 72 of the member 10, and the longitudinal abutment of the member 10 is provided by the transverse faces 80 of the bottom of the housing 73 of the member 10 which are received in abutment against the end 82 of said first terminal piece 20. Vertical retention of the member 10 is provided by the wings 106 of the first terminal piece 20 of the first arm 22, and the locking of the member 10 is provided by the first push button 26 which is received in the hole 2520 of said first terminal piece 20.

As illustrated in FIG. 11, the member 10 is immobilised by the lateral walls 26 of the second terminal piece 21 of the arm 23 of the second type which receive the lateral walls 18 of the member 10, and the longitudinal abutment of the member 10 is provided by the transverse faces 80 of the member 10 which are received in abutment against the end 82 of said second terminal piece 21, Vertical retention of the member 10 is provided by the wings 106 of the second terminal piece 21 of the second arm 23, and the locking of the member 10 is provided by the first push button 28 which is received in the hole 2521 of said second terminal piece 21.

As illustrated in FIG. 12, the member 10 is immobilised by the lateral walls 26 of the third terminal piece 34 of the arm 36 of the third type which receive the lateral walls 18 of the member 10, and the longitudinal abutment of the member 10 is provided by the transverse faces 80 of the member 10 which are received in abutment against the end 82 of said third terminal piece 36. Vertical retention of the member 10 is provided by the wings 106 of the third terminal piece 34 of the third arm 36, and the locking of the member 10 is provided by the second push button 38 which is received in the hole 2534 of said third terminal piece 34.

As illustrated in FIG. 13, the member 10 is immobilised by the lateral walls 26 of the fourth terminal piece 44 of the fourth arm 46 which receive the lateral walls 18 of the member 10. Vertical retention of the member 10 is provided by the wings 106 of the fourth terminal piece 44 of the fourth arm 46, and the locking of the member 10 and also its longitudinal immobilisation is provided by the third push button 48 which is received in the hole 2544 of said fourth terminal piece 44.

As illustrated in FIG. 14, the member 10 is immobilised by the lateral walls 26 of the fifth terminal piece 60 of the fifth arm 64 which receive the lateral walls 18 of the member 10. The longitudinal abutment of the member 10 is provided by the transverse faces 80 of the member 10 which are received in abutment against the end 82 of said fifth terminal piece 60. The locking of the member 10 is provided by the fourth lateral buttons 68 which are received in the notches 2560, and the vertical retention of the member 10 is provided by the inclined edges 116 of the fourth push buttons 68 which interact with the complementary edges 118 of the notches 2560 for receiving said fourth buttons 68 and by the fourth notch 88 which receives the end tab 92 of the fifth terminal piece 60 of the fifth arm 64. Longitudinal abutment of the member 10 may also be provided in part by the fourth notch 88 which receives the end tab 92 of the fifth terminal piece 60 of the fifth arm 64.

Lastly, as illustrated in FIG. 15, the member 10 is immobilised by the lateral walls 26 of the sixth terminal piece 62 of the sixth arm 66 which receive the lateral walls 18 of the member 10, and the longitudinal abutment of the member 10 is provided by the fifth tabs 100 of the member 10 that extend in contact with the complementary tab 102 of the sixth arm 66 extending in parallel under the upper wall 24 of said sixth arm 66.

The locking of the member 10 is provided by the fourth lateral buttons 68 which are received in the notches 2562, and the vertical retention of the member 10 is provided by the end tab 92 which extends under the upper wall 90 of the head 15 and by the hooked ends 114 of the fifth tabs 100, which tabs interact with the complementary tab 102 of the sixth arm 66 extending in parallel under the upper wall 24 of said sixth arm 66.

The invention thus proposes a member 10 forming an adapter suitable for selectively interacting with a large number of terminal pieces of windscreen wiper arms, which allows considerable simplification of the mounting of windscreen wiper blades 12 on different arms 22, 23, 36, 46, 64, 66.

1. A member for a connection system between a windscreen wiper blade and a driving arm of said blade, said member being of substantially longitudinal orientation and comprising:
at least one body having substantially a U-shaped cross section comprising a base and two lateral walls;
at least a first retractable locking means configured to interact with an arm having a terminal piece of a first type, said first locking means comprising at least a first elastic tab; and
at least a second retractable locking means configured to interact with an arm having a terminal piece of a second type, said second locking means comprising at least a second elastic tab,
wherein the first and second elastic tabs start from the base and extend at least in part in a thickness of the base.

2. The member according to claim 1, wherein the first elastic tab, called first tab, comprises at least two arms connected to the base of the body of the member, between which a notch is delimited.

3. The member according to claim 2, wherein the second locking means extends into the notch.

4. The member according to claim 1, wherein the first and second locking means are constituted at least by respective first and second push buttons that extend in the thickness of the base or above the base.

5. The member according to claim 4, wherein the first push button is provided at a distal end of the first elastic tab.

6. The member according to claim 4, wherein the second push button is provided at a distal end of the second elastic tab.

7. The member according to claim 1, further comprising a means of pivoting about a transverse axis, in which the body has the shape of a U, comprising at least the upper wall and the two lateral walls, provided in line with the means of pivoting.

8. The member according to claim 1, wherein the first and second elastic tabs extend in accordance with the longitudinal orientation of the member.

9. The member according to claim 1, further comprising a third locking means configured in order to interact with an arm having a terminal piece of a third type, said third locking means comprising at least a third elastic tab extending from an internal face of one of the lateral walls of the body.

10. The member according to claim 9, wherein the body comprises a first end via which it is capable of being inserted into each terminal piece, and a second end, opposite the first end, and wherein the first, second and third locking means are aligned longitudinally between the first and second ends.

11. The member according to claim 10, further comprising a fourth locking means configured in order to interact with an arm having a terminal piece of a fourth type, said fourth locking means comprising at least a fourth elastic tab extending in the continuation of at least one of the lateral walls of the body.

12. The member according to claim 10, further comprising a head formed at the second end of the member.

13. The member according to the claim 12, wherein a housing for receiving at least one of the terminal pieces of the arm is arranged between the body and at least one wing lateral to the body, emerging from the head.

14. The member according to claim 1, characterised in that it is produced by injection-moulding of a plastics material.

15. A windscreen wiper blade comprising a member according to claim 1.
